(19) United States
(12) Patent Application Publication
(10) Pub. No.: US 2015/0304647 A1
(43) Pub. Date: Oct. 22, 2015

(54) stereoscopic viewing apparatus and display synchronization

(71) Applicant: NORDIC SEMICONDUCTOR ASA, Trondheim (NO)

(72) Inventors: LASSE HAUGNES OLSEN, TRONDHEIM (NO); FRANK BERNTSEN, HEIMDAL (NO); RUNE BRANDSEGG, STJORDAL (NO)

(73) Assignee: NORDIC SEMICONDUCTOR ASA, Trondheim (NO)

(21) Appl. No.: 14/648,665

(22) PCT Filed: Nov. 28, 2013
(86) PCT No.: PCT/GB2013/053149

§ 371 Date: May 29, 2015

(30) Foreign Application Priority Data
Nov. 30, 2012 (GB) 1221627.1

(51) Int. Cl. H04N 13/04; G09G 5/18

(52) U.S. Cl. CPC H04N 13/0497; H04N 13/0429; G09G 5/18; G09G 2370/16

(57) ABSTRACT

A stereoscopic viewing apparatus (16) is synchronized with a display (2). A signal(8) generated by or synchronised with the display (16) is transmitted. The signal (8) comprises a sequence of data packets (204), wherein each data packet (202a-e) in the sequence comprises an identifying portion of data. The stereoscopic viewing apparatus (16) receives a data packet (202b) from the sequence of data packets (204). A position of the data packet (202b) in the sequence of data packets (204)is identified using said identifying portion. Timing information related to the data packet (202b) is determined using said position. The timing information is used for synchronization of the stereoscopic viewing apparatus(16) with the display (2) and for determining when to activate a receiver(22) in the stereoscopic viewing apparatus (16) for receiving a subsequent packet.

The present invention relates generally to stereoscopic display systems, and particularly to robust, power-managed systems and associated methods for synchronizing stereoscopic viewing apparatus with a display.

It is known in the art to create a perception of viewing a three-dimensional image by providing to respective left and right eyes two-dimensional images of left and right points of view. It is also known that this can be achieved for moving three-dimensional images by providing moving left and right perspective moving images.

Various methods are known in the art for ensuring that the left perspective image is viewed only by the left eye, and the right perspective image only by the right eye, including the use of complementary colour filter glasses, linearly or circularly polarizing glasses, and shutter glasses.

The limitations of complementary colour filter glasses, particularly their limited ability to provide true colour images, are well recognised in the art. Polarizing glasses also have disadvantages, including their reliance on expensive projectors and screens to provide the polarized light and to preserve the polarization until the light reaches the polarizing glasses. Shutter glasses may be preferred to avoid problems such as those mentioned above, but nevertheless have other problems as discussed below.

Display systems incorporating shutter glasses comprise a display screen showing alternating left and right perspective images, and a pair of shutter glasses worn by the viewer. The shutter glasses are configured so that the left eye shutter is translucent while the left perspective image is displayed and opaque while the right perspective image is displayed, and so that the right shutter is translucent while the right perspective image is displayed and opaque while the left perspective image is displayed.

To ensure the viewer perceives a smooth image, the left and right perspective images must be alternated at a sufficiently high frequency that the user perceives the image provided to each eye as continuous rather than flickering. Commonly used frequencies in the art include 50 Hz, 60 Hz, 100 Hz and 120 Hz, although other frequencies can be used and the invention disclosed herein is not limited to any particular frequency or frequencies. This requires that the shutters of the glasses are synchronized to the alternating images on the display with high temporal precision, and even a small error (of the order of tens of milliseconds) in the timing of the shutters can result in undesirable visual artefacts in the displayed image, e.g. flickering or ghosting (where the left image is visible to the right eye and/or the right image is visible to the left eye).

Local timers in the glasses and display, although initially synchronized, generally will not maintain their synchronization if left to run independently. To maintain synchronization therefore requires frequent or continuous communication between the display and the glasses. In some systems, this is achieved using infra-red (IR) signals. For example, a square wave may be transmitted from the display to the glasses, where a high signal corresponds to a left perspective image (and therefore the left shutter is changed to a translucent state) and a low signal corresponds to a right perspective image (and the right shutter is changed to a translucent state).

However, there are disadvantages associated with IR communication, including noise interference from ambient IR sources and interruption of the IR communication if the line of sight from the display to the glasses is blocked, e.g. by people or objects moving in the vicinity of the display.

International patent application WO 2010/141514 discloses a 3D viewing system and associated protocol which utilises radio frequency (RF) signals for communication between a display and 3D glasses, which avoids the problem of interference from ambient IR sources and ameliorates the line-of-sight problem due to the longer wavelength of RF radiation.

A further problem associated with shutter glasses is ensuring that the communication protocol for synchronization is robust. One method of addressing this problem that is used in the prior art is to make the communication between the display and the glasses two-way, i.e. an acknowledgment (“ACK”) signal is sent from the glasses to the display in response to a signal received by the glasses from the display. The arrival of an ACK signal (or absence of an expected ACK signal) provides information to the display system about whether or not a signal has been received by the glasses. This allows the display to compensate for problems in the transmission of the signal to the glasses, such as dropped packets. However, this limits the number of pairs of glasses that can be used with the display at the same time.

A further disadvantage of stereoscopic viewing systems using shutter glasses is that the frequent communication required to maintain synchronization of the shutters with the images demands a lot of energy. It is most convenient for the viewer if the glasses are provided with an internal power supply (e.g. a battery) so as to be free from wire connections to an external power supply. However, the power demands of the communication protocol can result in the battery becoming depleted quickly, requiring frequent replacement of the battery.

Although the complexity associated with requiring synchronisation between the display and a single pair of 3D glasses may be practicable to deal with, additional problems are introduced when it is desired to view a display such as a television with multiple pairs of glasses as it then becomes necessary for each pair to be operated in synchrony with the display at the same time. However the greater the number of glasses, the greater the bandwidth required to achieve this and this can soon make such an approach impractical.

When viewed from a first aspect the invention provides a method for synchronizing a stereoscopic viewing apparatus with a display, the method comprising:
transmitting a signal generated by or synchronised with the display comprising a sequence of data packets, wherein each data packet in the sequence comprises an identifying portion of data;
the stereoscopic viewing apparatus receiving a data packet from the sequence of data packets;
identifying a position of the data packet in the sequence of data packets using said identifying portion;
determining timing information related to the data packet using said position; and
using the timing information for synchronization of the stereoscopic viewing apparatus with the display and for determining when to activate a receiver in the stereoscopic viewing apparatus for receiving a subsequent packet.

The invention extends to a viewing apparatus for implementing a method according to the first aspect. Thus, when viewed from a second aspect, the invention also provides a stereoscopic viewing apparatus comprising:
a receiver configured to receive a data packet from a signal comprising a sequence of data packets; and
processing means configured to:
   identify a position of the data packet in the sequence of data packets using an identifying portion of data in the data packet;
   determine timing information related to the data packet using said position; and
   use the timing information for synchronization of the stereoscopic viewing apparatus with a display and for determining when to activate the receiver in the stereoscopic viewing apparatus for receiving a subsequent packet.

The provision of an identifying portion in each data packet allows timing information required for synchronization to be determined from just one received packet, even if it is not the first packet in the sequence, i.e. the transmission time of the sequence of data packets may be determined from the arrival time of a data packet and the position of the data packet in the sequence as determined from the identifying portion. This provides redundancy of information in the sequence of data packets to provide greater tolerance of transmission errors such as dropped packets such that there is no need to provide an ACK signal. The advantage of this is that the method and apparatus of the invention can be used to implement a broadcast protocol that is sufficiently robust to be used for synchronising timers. Thus it is possible for the system to exploit advantages of the broadcast protocol that would not be available for protocols using an ACK signal. For example, an advantage of using a broadcast protocol is that the display system can, in principle, support an unlimited number of pairs of glasses.

As redundancy is provided by the equivalence of the timing information that can be derived from a received data packet, regardless of which packet in the sequence is received, it is not necessary to provide a payload portion in each data packet to provide redundancy in the timing information. However, it may be desirable to include a payload portion. If a payload portion is provided, it is desirable to provide identical information in the payload portion of each data packet in the sequence so that the information is received, irrespective of which data packet in the sequence is received. Thus in some embodiments at least one data packet in the sequence contains a portion of data that is identical to a corresponding portion of data in a further data packet in the sequence. The payload portion may follow an identifying portion of data and/or a portion of data relating to a subsequent receiving frequency. However, the portions of data may be provided in any suitable order. The payload portion may contain, as a non-limiting example, audio data.

The invention extends to a display apparatus for implementing such a method. Thus, when viewed from a third aspect, the invention provides a display apparatus comprising a transmitter arrangement configured to transmit a signal comprising a sequence of data packets, wherein each data packet in the sequence comprises:
an identifying portion of data that is different from the identifying portion in each other data packet in the sequence; and
a payload portion of data that is identical to the payload portion in at least one other data packet in the sequence.

In some embodiments, the payload portion of data in a data packet in a sequence is identical to the payload portion in each other data packet in the sequence.

In accordance with aspects of the invention, the use of the timing information to determine when to activate a receiver for receiving a subsequent packet permits the deactivation of the receiver when it is not needed, e.g. after a packet has been received until the time that the next packet is expected. In some embodiments, the receiver is deactivated if a pre-determined number of packets has been received. In some embodiments, the pre-determined number of packets is one. It will been seen by one skilled in the art that the deactivation of the receiver in accordance with the invention reduces the power consumption of the glasses, thereby extending the life of the power supply in the glasses. In some embodiments, a transmitter switches off when it is not transmitting. This reduces the power consumption of the display which may be advantageous (for example, if the display is powered by a battery).

In a set of embodiments therefore the method comprises subsequently transmitting a further sequence of data packets, wherein each data packet in the further sequence comprises an identifying portion of data; and activating the receiver to receive said further sequence at an expected arrival time. Accordingly, in some preferred embodiments the transmitter arrangement is configured to transmit a further sequence of data packets wherein each packet in the further sequence of packets comprises an identifying portion of data that is different from the identifying portion in each other data packet in the sequence; and a payload portion of data that is identical to the payload portion in at least one other data packet in the sequence. In some preferred embodiments the processing means of the stereoscopic viewing apparatus is further configured to activate the receiver to receive a further sequence of data packets at an expected arrival time.

The method of the invention may be tolerant of transmission errors such as dropped packets due to the need to receive only one of the data packets in the sequence in order to determine the timing information from the data packet. However, it will be appreciated by one skilled in the art that in some cases all of the data packets in the sequence might be dropped, i.e. none of the data packets is received by the receiver. In this situation, the timing information cannot be determined from a data packet. In this event, the synchronization of the viewing apparatus with the display may be maintained using the timing information determined from a packet in a previous sequence.

As noted above, it may be advantageous to deactivate the receiver when it is not needed, and it may be deactivated when a pre-determined number of packets has been received. However, if all of the packets are dropped, the receiver, having been activated to receive a further sequence at an expected arrival time, cannot deactivate on the basis of a number of packets received. In some embodiments the receiver is deactivated if a predetermined time interval from the expected arrival time has elapsed. This criterion for deactivating the receiver may be used in conjunction with deactivating the receiver if a pre-determined number of packets has been received, or it may be used irrespective of whether or not a packet has been received.

It is known in the art that a transmission protocol operating on a single frequency may experience noise from ambient sources, e.g. other devices operating on that frequency. A common approach to ameliorating the effects of such noise is to employ frequency hopping, in which the frequency of transmission is switched rapidly between frequencies so that at least some of the transmitted signal is broadcast on a frequency unaffected, or less affected, by the noise. However, to achieve frequency hopping requires synchronization of a transmitter and a receiver to ensure that the receiver is listening on the correct frequency at any given time. Maintaining this synchronization can be difficult, especially in a broadcast protocol as there is no ACK signal to enable the transmitter and receiver to compensate for dropped packets.

In accordance with some embodiments of the present invention a subsequent receiving frequency is determined from the data packet. Thus it will be appreciated by the skilled person that a receiving frequency can be matched to a transmitting frequency without relying solely on the transmitter and receiver adhering independently to matching frequency lists. In the event that all data packets in a sequence are dropped, it will not be possible to determine a subsequent receiving frequency from a received data packet in that sequence. In this event, the receiver may listen for a subsequent sequence without changing to a new receiving frequency. The receiver may continue to listen without changing to a new frequency until a data packet is received for example. The transmitter may employ frequency hopping between a finite number of pre-defined frequencies, in which case, the transmitter will after a short time revert to the frequency on which the receiver is listening, enabling the receiver to receive a data packet and to determine a further subsequent receiving frequency from the data packet, and thus to continue implementing the broadcast protocol with frequency hopping. Alternatively, instead of continuing to listen without changing receiving frequency, the receiver may determine a subsequent receiving frequency from a predetermined list of receiving frequencies or carry out a frequency measurement procedure.

Additionally or alternatively, the transmitter and receiver may adhere independently to matching frequency lists to match the receiving frequency to the transmitting frequency. In some embodiments, a transmission frequency of the sequence of data packets is selected from a list of transmission frequencies. In some embodiments, a subsequent receiving frequency is selected from a list of receiving frequencies. In the event that all data packets in a sequence are dropped, the receiver may continue to the next frequency in the list of receiving frequencies. Alternatively, the receiver may continue to listen without changing receiving frequency.

Where the receiver continues to listen without changing frequency, the receiver may listen continuously, or the receiver may be deactivated and then reactivated at an expected arrival time of a subsequent packet.

Any suitable frequency or frequencies may be used for transmitting and receiving the signal. In some embodiments, the signal is a radio signal.

The stereoscopic viewing apparatus may comprise any suitable device, but in a set of embodiments the stereoscopic viewing apparatus comprises a pair of glasses.

It will be appreciated that the stereoscopic viewing apparatus and the display apparatus described in accordance with the respective second and third aspects of the present invention are suitable for use in conjunction with each other to implement the method of the invention, and that more than one viewing apparatus may be used simultaneously in conjunction with a single display apparatus. Thus when viewed from a further aspect, the invention provides a display system comprising a display apparatus according to the third aspect of the invention; and at least one stereoscopic viewing apparatus according to the second aspect of the invention.

Certain preferred embodiments of the invention will now be described, by way of example only, with reference to the accompanying drawings, in which:

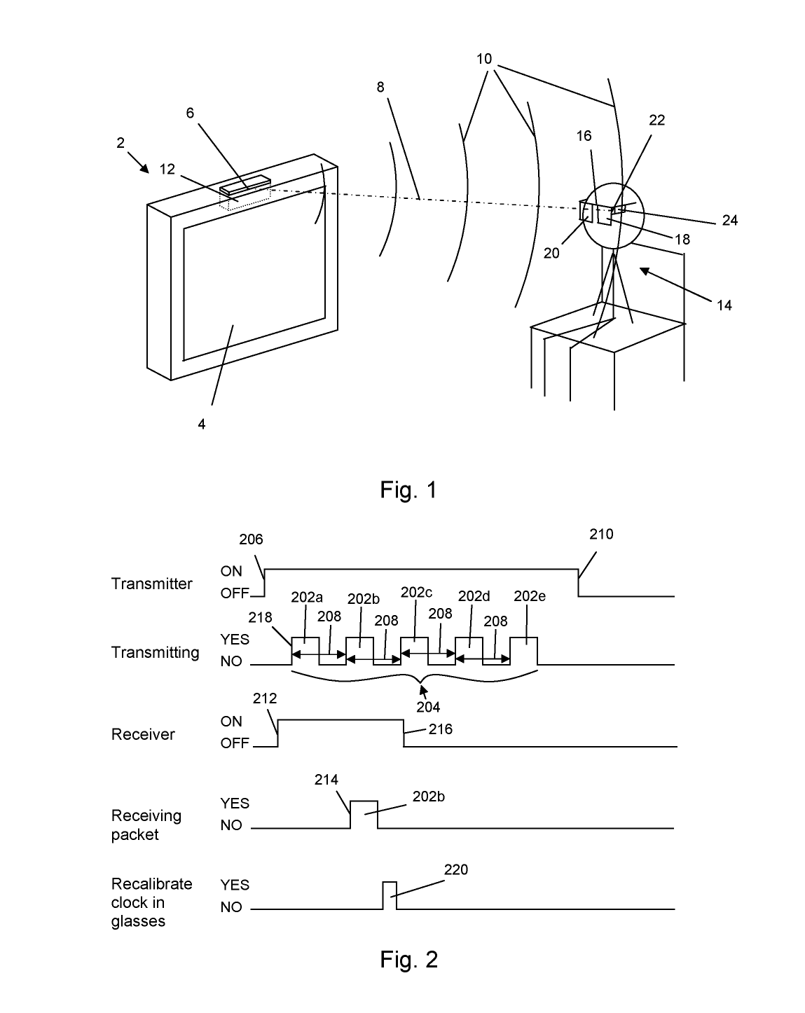

FIG. 1 shows a display system in accordance with an embodiment of the present invention comprising a display screen and a pair of glasses worn by a viewer;

FIG. 2 shows a schematic illustration of the broadcast protocol for a first cycle of transmission, as implemented by the display system of FIG. 1, for the case that a sequence of five packets is transmitted and the second packet in the sequence is received;

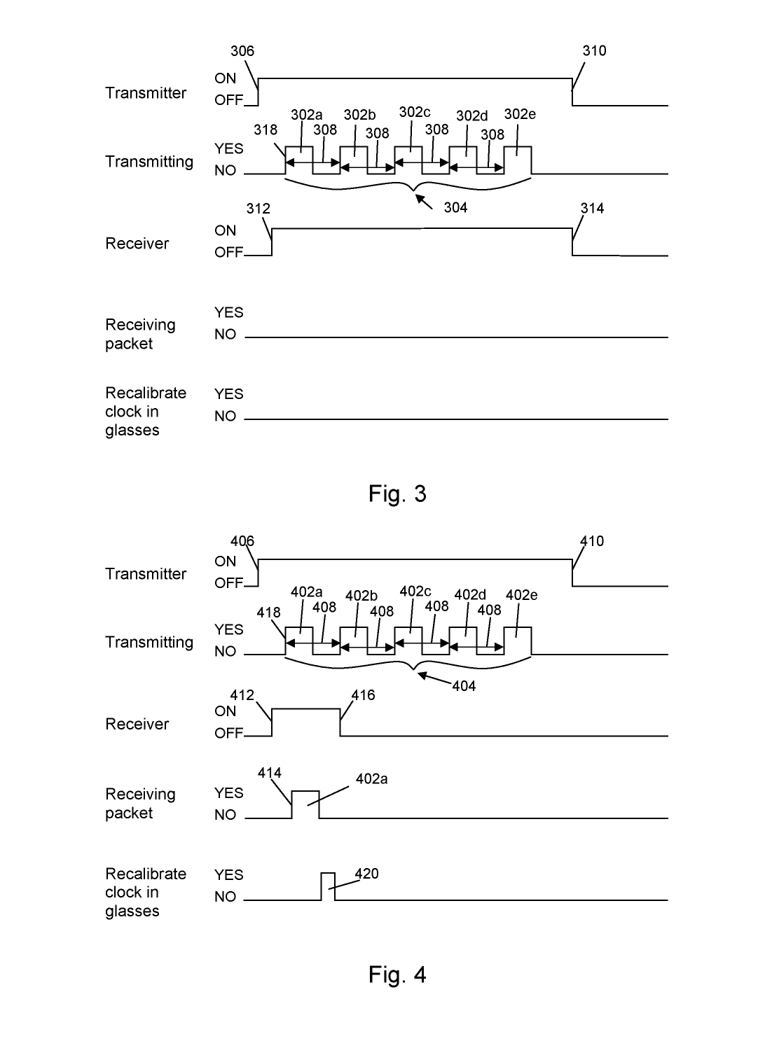

FIG. 3 shows a schematic illustration of the broadcast protocol for a second cycle of transmission for the case that a sequence of five packets is transmitted and none of the packets is received;

FIG. 4 shows a schematic illustration of the broadcast protocol for a further cycle of transmission for the case that a sequence of five packets is transmitted and the first packet in the sequence is received;

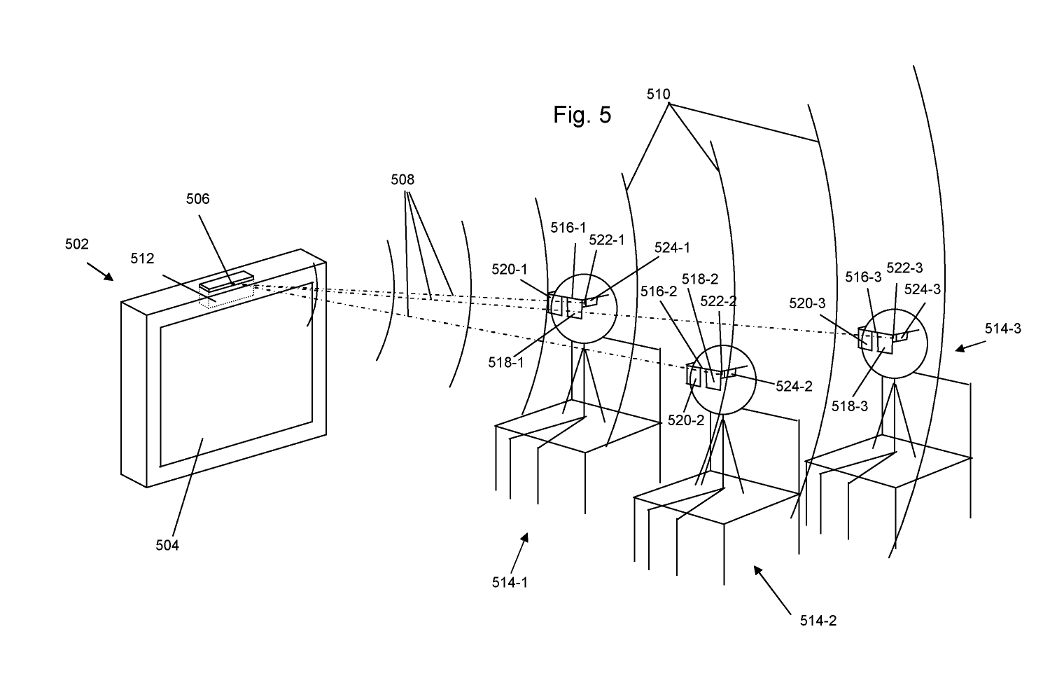

FIG. 5 shows a display system according to the present invention comprising a display screen and three pairs of glasses, each pair being worn by a viewer;

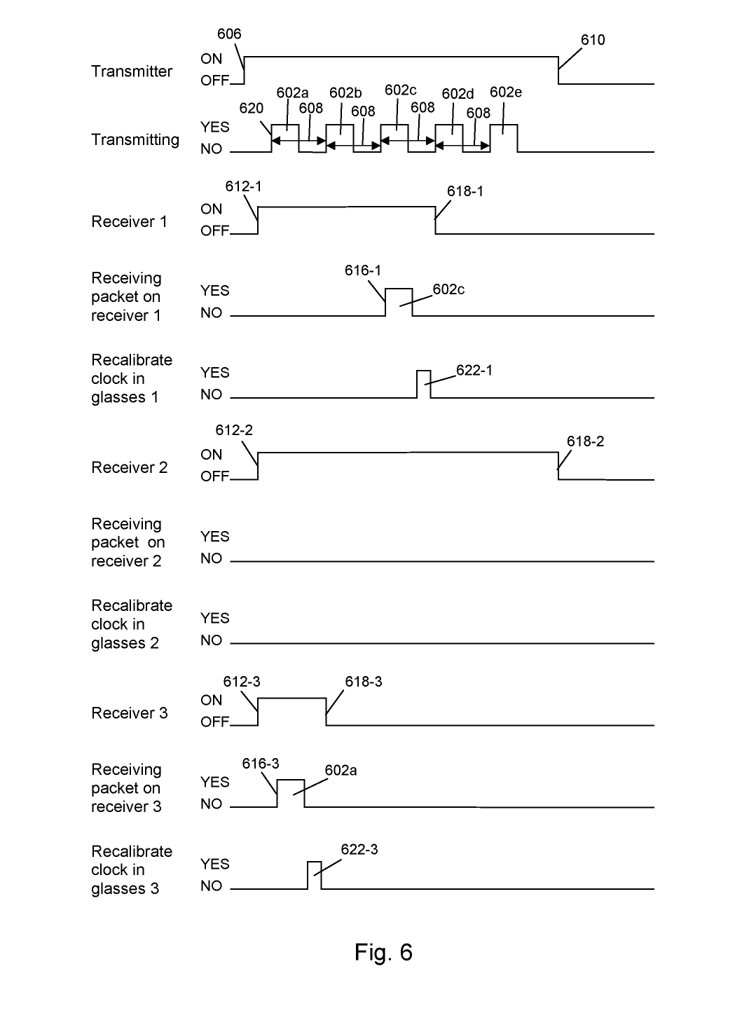

FIG. 6 shows a schematic illustration of the broadcast protocol for a first cycle of transmission, as implemented by the display system of FIG. 5, for the case that a sequence of five packets is transmitted and a first pair of glasses receives the third packet, a second pair of glasses does not receive a packet, and a third pair of glasses receives the first packet; and

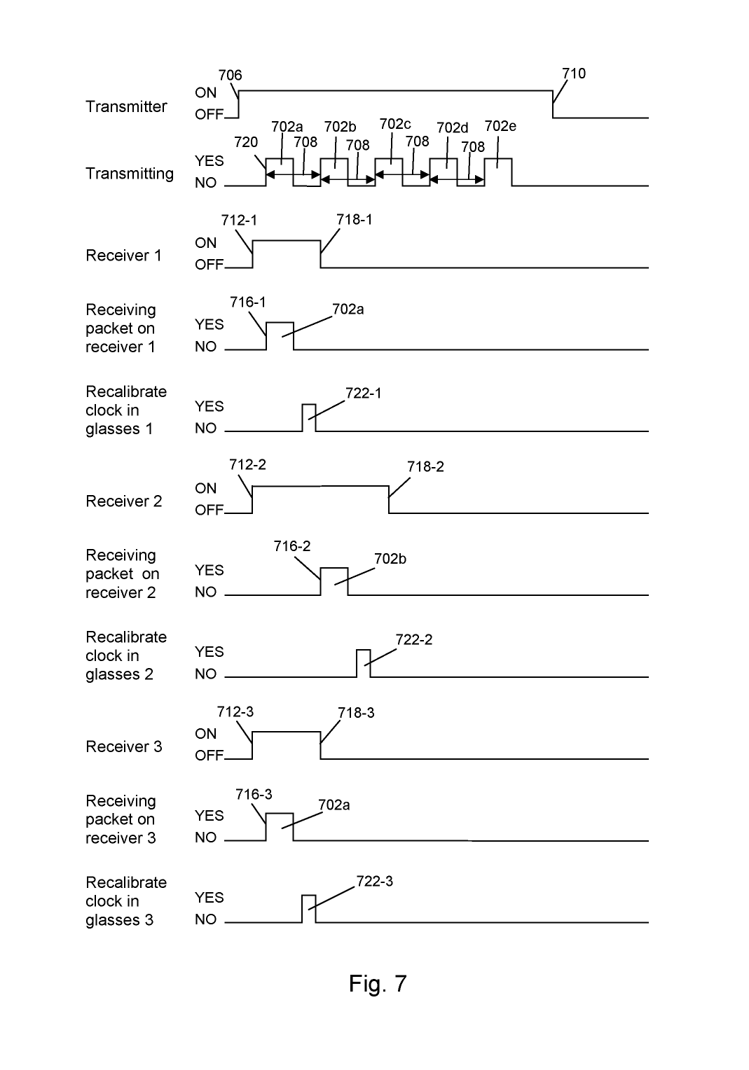

FIG. 7 shows a schematic illustration of the broadcast protocol for a second cycle of transmission for the case that a sequence of five packets is transmitted and the first and third pairs of glasses receive the first packet and the second pair of glasses receives the second packet.

FIG. 1 shows a television 2 with a screen 4 showing alternating left and right perspective images of a scene from a television programme. The television comprises a transmitter 6, which broadcasts a radio frequency signal represented by a ray 8 and wavefronts 10, and a control unit 12, which is in communication with the transmitter 6. The control unit 12 includes a system clock (not shown). A viewer 14 is seated with a line of sight to the screen 4 of the television 2. The viewer 14 is wearing stereoscopic (3D) shutter glasses 16 comprising left 18 and right 20 eyepieces, a receiver 22 and a controller 24 which is in communication with the receiver 22. The controller 24 also includes a clock (not shown). Each of the left and right eyepieces 16, 18 can be induced into a translucent state or an opaque state by a signal from the controller 24.

The 3D glasses 16 cause the viewer 14 to perceive a three-dimensional image on the screen 4 by permitting the transmission of the left perspective images through the left eyepiece 18 only and the right perspective images through the right eyepiece 20 only. This is achieved by the glasses controller 24 instructing the left eyepiece 18 to adopt a translucent state when left perspective images are displayed on the screen 4 and an opaque state when the right perspective images are displayed on the screen 4, and instructing the right eyepiece 20 to adopt a translucent state when right perspective images are displayed on the screen 4 and an opaque state when the left perspective images are displayed on the screen 4. Thus the states of the eyepieces 18, 20 are changed in synchronisation with the switching of the left and right perspective images. This requires the glasses' clock in the controller 24 to be synchronised with the switching of the left and right perspective images in order that the controller 24 can instruct the eyepieces 18, 20 to change state at the correct time. This is achieved by synchronising the system clock of the control unit 12 with the clock of the controller 24 using a broadcast protocol as described below.

FIG. 2 illustrates an exemplary cycle of a broadcast protocol in accordance with the present invention as employed in the embodiment depicted in FIG. 1. The transmitter 6 is activated at time 206 by the control unit 12. The transmitter 6 broadcasts a first sequence 204 of five data packets 202a-e on a frequency of 2.423 GHz with an interval length 208 of 500 μs between each data packet 202a-e. The frequency is selected by the control unit 12 e.g. randomly or pseudo-randomly from a list of transmission frequencies: 2.403, 2.423, 2.440, 2.461 and 2.475 (GHz). The skilled person will appreciate that the frequency of the broadcast of the first series, the interval length, and any or all of the frequencies in the list of transmission frequencies may take different values from the example values given above. Although in the example given above, the list of transmission frequencies comprises five frequency values, the list of transmission frequencies may comprise any number of frequency values. Each packet 202a-e contains a payload portion of data preceded by two bytes of information: the packet number (1 byte) and an indicator of the frequency that will be used for the next transmission (1 byte), which in the example given above might be 2.403 GHz. Once the five data packets 202a-e have been transmitted, the transmitter 6 is deactivated at a time 210 to conserve power.

The receiver 22 is activated by the controller 24 at a time 212, which is a short time before an expected arrival time of the first packet 202a in the sequence 204, where the expected arrival time of the first data packet 202a is calculated from an arrival time of an earlier packet from an earlier sequence and either a pre-defined inter-broadcast delay time stored in a memory (not shown) associated with the controller 24 or data contained in an earlier packet.

Once activated, the receiver 22 listens on the frequency of 2.423 GHz, which is determined from an earlier received packet. In the example illustrated in FIG. 2, the first packet 202a in the first sequence 204 of data packets 202a-e is not received. The receiver 22 remains active. The second packet 202b in the sequence 204 is received at an arrival time 214. The receiver 22 is then deactivated a short time after, at time 216.

In the case that the glasses and display have just been switched on, no earlier packet will have been received from which the controller 24 can determine an earlier arrival time of an earlier packet. If no earlier packets have been received, the receiver 22 is activated when the 3D glasses 16 are switched on and listens for data packets on a predefined first frequency, which is one of the frequencies in the list of transmitting frequencies used by the transmitter.

The receiver may listen until a data packet is received or until a pre-determined time has elapsed since the glasses 16 were switched on (which prevents the battery being depleted in the event of the glasses being accidentally switched on when the television is not switched on and no packets are being transmitted). The receiver may reactivate for one or more subsequent periods to listen for again for packets on the predefined first frequency When the transmitter transmits on the pre-defined first frequency, the receiver can receive a packet and then proceed to determine the next receiving frequency from the packet data. The receiver may listen for progressively longer periods. This prevents the battery being unnecessarily depleted if the glasses are switched on before the display.

When a broadcast is initiated according to the described configuration of the present embodiment, the transmitter always broadcasts five packets in each sequence with an inter-packet delay of 500 μs. The packet number allows the packets to be distinguished by the controller 24. The controller 24 can thus determine the time that has elapsed since the transmission 218 of the first packet 202a by accounting for the interval 208 between the packets 202a-e and other, additional delays that result from initiating packet transmission, the packet transmit time between the transmitter 6 and receiver 22, and the time for decoding the packet 202b after it has been received. These additional delays will always be a fixed length depending on air data rate and the clock frequency of the processing means 12, 24.

The time since the start of transmission 218 can then be calculated according to:

TimeSinceTransmission=InitializationDelay+TransmitTime+DecodeTime+(PacketNumber−1)*InterpacketDelay.

In an exemplary embodiment, the delay from initializing packet transmission (InitializationDelay) is 53 μs, the packet transmit time (TransmitTime) is 281 μs and the time for decoding the packet on the receiver side (DecodeTime) is 219 μs. However, one skilled in the art will appreciate that in other embodiments of the invention the InitializationDelay, TransmitTime, DecodeTime and interpacketDelay may have different values. In the example illustrated in FIG. 2, where the first packet 202a is not received and the second packet 202b is received:

TimeSinceTransmission=53 μs+281 μs+219 μs+(2−1)*500 μs=1053 μs.

Calibration 220 of the clock in the 3D glasses 16 is then performed using the time since transmission 218 of the first data packet 202a in the first sequence 204. As noted above, it is necessary to perform this calibration frequently to ensure that errors associated with clock drift are kept within acceptable limits. FIG. 3 illustrates an operation of the broadcast protocol directly after the period illustrated in FIG. 2.

The transmitter 6 is reactivated at a time 306 by the control unit 12, and broadcasts a second sequence 304 of five data packets 302a-e, this time on a frequency of 2.403 GHz with an inter-packet interval 308 of 500 μs. As in the example illustrated in FIG. 2, in addition to the payload data, each data packet 302a-e includes a packet number (1 byte) and an indicator of the frequency of transmission of the next sequence of data packets (1 byte) which might be say 2.440 GHz. After this second sequence 304 of data packets 302a-e has been transmitted, the transmitter is deactivated at a later time 310.

The receiver 22 is reactivated at time 312 by the controller 24 a short time before an expected arrival of the first packet 302a in the second sequence 304, where the expected arrival time of the first data packet 302a is determined from the arrival time 214 of the received packet 202b from the first sequence 204 (as discussed with reference to FIG. 2).

Once activated, the receiver 22 listens on a frequency of 2.403 GHz, which is determined from the packet 202b received from the first sequence 204 of data packets 202a-e. In the example illustrated in FIG. 3, none of the data packets 302a-e in the sequence 304 is received. After a pre-defined time period has elapsed following the expected arrival time of the first packet 302a, the receiver 22 is deactivated at time 314 to conserve power.

Moreover, as none of the data packets 302a-e is received, the controller 24 is unable to determine the transmission time 318 of the first data packet. Instead, the glasses clock continues to run without a recalibration on this occasion.

As no packet was received from the broadcast described with reference to FIG. 3, the controller 24 cannot determine a subsequent receiving frequency. Instead, based on the clock in the glasses and the inter-transmission interval of the transmitter, the receiver is switched on periodically at expected transmission times to listen for packets on the same frequency on which it listened for the second broadcast (i.e. the first time following receipt of a packet when no packet was received for an expected sequence). In this example, this frequency is 2.403 GHz.

The transmitter is reactivated periodically, and each time broadcasts a sequence of packets, using one of the frequencies 2.440 GHz, 2.461 GHz, 2.475 GHz, 2.423 GHz (these broadcast cycles are not illustrated in the figures) and then back to 2.403 GHz. The receiver switches on a short time before each broadcast to listen for packets, but always listens on 2.403 GHz. When the transmitter broadcasts on 2.403 GHz, the receiver is then able to receive a packet, and to continue to determine timing information and subsequent receiving frequencies from received packets.

Of course if the sequence of frequencies used is predetermined, this procedure is not necessary.

The broadcast on 2.403 GHz as mentioned above is shown in FIG. 4 and described below. The transmitter 6 broadcasts a further sequence 404 of five data packets 402a-e on a frequency of 2.403 GHz with an interval 408 of 500 μs between each data packet. As in the previous cases, each packet 402a-e contains a payload portion of data preceded by two bytes of information: the packet number (1 byte) and the frequency that will be used for the next transmission (1 byte), which might be say 2.440 GHz. Once the five data packets 402a-e have been transmitted, the transmitter is deactivated at a time 410 to conserve power.

The receiver 22 is reactivated at a time 412 by the controller 24 a short time before an expected arrival of the first packet 402a in the further sequence 404. No packet was received when the receiver 22 switched on and listened for the packets 302a-e in the second sequence 304, or the sequences following the second sequence 304, and so the expected arrival time cannot be determined from the arrival time of a packet from any of these sequences. Instead, the expected arrival time is determined from the arrival time of a packet in an earlier sequence, which in this case is the packet 202b received from the first sequence 204 (i.e. the most recently received packet).

As the glasses' clock was not calibrated after the second cycle of the broadcast protocol (because no packet was received), it may have drifted relative to the system clock, and so there may be a greater difference between the expected arrival time of the first packet in the further sequence and an actual arrival time of the first packet in the further sequence than there would have been if the clock in the glasses had been recalibrated. However, the receiver is activated a short time before the expected arrival time, where the short time is long enough to compensate for a difference in the expected and actual arrival times of the first data packet, even in cases where the clock in the glasses has been running without calibration for a number of cycles of the broadcast protocol. The number of broadcast cycles in which no packet is received that can be tolerated (i.e. for which the system clock and the glasses clock can remain sufficiently well synchronised for the broadcast protocol to work and also for the viewer to be able to view the display without significant visual artefacts or disturbances) can be set taking into account the relative drifts of the two clocks.

In the example illustrated in FIG. 4, the first packet 402a in the sequence 404 of data packets 402a-e is received. The receiver 22 is then deactivated at time 416.

The time since the start of transmission 418 is then calculated according to:

TimeSinceTransmission=InitializationDelay+TransmitTime+DecodeTime+(PacketNumber−1)*InterpacketDelay.

The delay from initializing packet transmission (InitializationDelay) is 53 μs, the packet transmit time (TransmitTime) is 281 μs and the time for decoding the packet 402a on the receiver side (DecodeTime) is 219 μs. These figures are the same as in the case of the first sequence 204 as discussed with reference to FIG. 2 because, as noted previously, these values are fixed for a particular implementation. In the example illustrated in FIG. 4, where the first packet 402a is received:

TimeSinceTransmission=53 μs+281 μs+219 μs+(1−1)*500 μs=553 μs.

Calibration 420 of the clock in the 3D glasses 16 is then performed using the time since transmission 418 of the first data packet 402a in the further sequence 404.

In the embodiment described above with reference to FIGS. 1-4, the broadcast protocol is applied to a system comprising a television 2 and a single pair of glasses 16. However, as noted above, an advantage of the broadcast protocol is that the protocol can be used simultaneously by more than one pair of 3D glasses receiving data packets from one television.

FIG. 5 shows an embodiment of the present invention identical to that illustrated in FIG. 1, except that in addition to a first viewer 514-1 wearing a first pair of glasses 516-1, there are two additional viewers 514-2, 514-3 wearing second and third pairs of glasses 516-2, 516-3. Further, in contrast with the previously described embodiment, if none of the packets in a sequence is received by a receiver in one of the pairs of glasses, instead of listening for further packets without changing the listening frequency, the receiver listens on a frequency determined from a pre-defined list of frequencies as explained further below. This alternative method of determining a subsequent listening frequency is not necessarily associated with display systems having more than one pair of glasses. Any suitable method for determining a subsequent receiving frequency may be used, irrespective of the number of pairs of glasses.

First, second and third pairs of glasses 516-1; 516-2; 516-3 comprise respective left 518-1; 518-2; 518-3 and right 520-1; 520-2; 520-3 eyepieces, respective first, second and third receivers 522-1; 522-2; 522-3 and respective first, second and third controllers 524-1; 524-2; 524-3 which are in communication with the respective receivers 522-1; 522-2; 522-3. The controllers 524-1; 524-2; 524-3 are also in communication with respective first, second and third clocks (not shown) provided in each pair of glasses 516-1; 516-2; 516-3. Each pair of glasses 516-1; 516-2; 516-3 functions in the same manner as the pair of glasses 6 described with reference to FIG. 1.

A television 502, as in the case described with reference to FIGS. 1-4, comprises: a screen 504; a transmitter 506, which broadcasts a radio frequency signal represented by a ray 508 and wavefronts 510; and a control unit 512 in communication with the transmitter 506. The control unit 512 is also in communication with a system clock (not shown). There is therefore a single transmitter 506 broadcasting packets to be received by the respective receivers 522-1; 522-2; 522-3 of all three pairs of glasses 516-1; 516-2; 516-3.

The broadcast protocol is carried out with the control unit 512 performing the steps carried out by the control unit 12 as described previously with reference to FIGS. 2-4, and with each controller 524-1; 524-2; 524-3 independently carrying out the steps performed by the controller 24 as described previously. This is explained further below with reference to FIGS. 6-7, which illustrate two consecutive exemplary cycles of the broadcast protocol by the three pairs of glasses 516-1; 516-2; 516-3.

A first exemplary broadcast cycle is illustrated in FIG. 6. The transmitter 506 is activated by the control means 512. The transmitter 506 broadcasts a first sequence of five data packets 602a-e on a frequency of 2.403 GHz with a delay of 500 μs between each data packet. The frequency is selected according to a pre-defined pattern by the control unit 512 from a cyclic list of transmission frequencies: 2.403, 2.423, 2.440, 2.461 and 2.475 (GHz). Each packet contains a payload portion of data preceded by two bytes of information: the packet number (1 byte) and the frequency that will be used for the next transmission (1 byte), which in the broadcast cycle illustrated in FIG. 6 is 2.423 GHz although the skilled person will appreciate that this information is strictly redundant given the cycling of frequencies.

Once the five data packets 602a-e have been transmitted, the transmitter 506 is deactivated to conserve power.

Each of the first, second and third receivers 522-1; 522-2; 522-3 is activated by its respective controller 524-1; 524-2; 524-3 a short time before an estimated arrival time of the first data packet 602a in the first sequence. The estimated arrival time of the first packet 602a in the first sequence is determined for each receiver 522-1; 522-2; 522-3 by its respective controller 524-1; 524-2; 524-3 from the arrival time of a packet in an earlier sequence of data packets.

Once activated, each receiver 522-1; 522-2; 522-3 listens on a frequency of 2.403 GHz, which is determined from the cyclic list of frequencies.

If no earlier packets have been received, e.g. if this is the first time the broadcast protocol is implemented following the glasses being switched on, each receiver 522-1; 522-2; 522-3, following activation, determines a first receiving frequency and listens for a data packet in the same way as receiver 22 in the embodiment described above. As the glasses may be switched on at different times, one or pairs of glasses may listen on a first receiving frequency for a first packet following the glasses being switched on, while one or more other pairs of glasses (having been switched on earlier, i.e. before an earlier sequence was broadcast) may be able to determine a receiving frequency from an earlier received packet.

In the example illustrated in FIG. 6, the first receiver 522-1 receives the third packet 602c in the first sequence, the second receiver does not receive a packet, and the third receiver 522-3 receives the first packet 602a in the first sequence.

The first and third receivers 522-1; 522-3 are deactivated by their respective controllers 524-1; 524-3 after the respective packets are received. The second controller 524-2 deactivates the second receiver 522-2 when a pre-defined time period has elapsed following the expected arrival time of the first packet 602a in the first sequence. Thus all three receivers 522-1; 522-2; 522-3 are inactive when packets are no longer expected, thereby conserving power.

The first and third controllers 524-1; 524-3 calculate the time since transmission of the first packet 602a in the first sequence according to:

TimeSinceTransmission=Initialization Delay+TransmitTime+DecodeTime+(PacketNumber−1)*InterpacketDelay.

For the first pair of glasses 516-1, whose receiver 522-1 receives the third packet 602c, the time since transmission is:

TimeSinceTransmission=53 μs+281 μs+219 μs+(3−1)*500 μs=1553 μs.

In this embodiment, the Initialization Delay, TransmitTime and DecodeTime delay values are the same as in the embodiment previously described with reference to FIG. 1, however the skilled person will appreciate that these delays will have different values depending on the particular implementation.

For the third pair of glasses 516-3, whose receiver 522-3 receives the first packet 602a, the time since transmission is:

TimeSinceTransmission=53 μs+281 μs+219 μs+(1−1)*500 μs=553 μs.

Using the calculated values of the time since transmission, the first and third clocks are recalibrated.

The second controller 524-2 is unable to calculate a time since transmission of the first data packet 602a as no packets were received by the second receiver 522-2, and so the second clock continues to run without recalibration.

FIG. 7 illustrates a further exemplary broadcast cycle that is immediately subsequent to the broadcast cycle described with reference to FIG. 6.

The transmitter 506 is reactivated by the control unit 512. The transmitter 506 broadcasts a second sequence of five data packets 702a-e on a frequency of 2.423 GHz with an interval of 500 μs between each data packet. As in the previous broadcast, each packet contains a payload portion of data preceded by two bytes of information: the packet number (1 byte) and the frequency that will be used for the next transmission (1 byte), which in the broadcast cycle illustrated in FIG. 6 is 2.440 GHz. Once the five data packets 702a-e have been transmitted, the transmitter 506 is deactivated to conserve power.

The first, second and third receivers 522-1; 522-2; 522-3 are reactivated by their respective controllers 524-1; 524-2; 524-3 a short time before an estimated arrival time of the first data packet 702a in the second sequence.

The first controller 524-1 determines the expected arrival time of the first data packet 702a in the second sequence from the arrival time of the data packet 602c previously received from the first sequence. The first receiver 522-1 listens on a frequency of 2.423 GHz, which the first controller 524-1 determines from the packet 602c received from the first sequence.

The second controller 524-2 cannot determine an expected arrival time from an arrival time of a data packet from the first sequence as no data packet was received. Instead the second controller 524-2 determines the expected arrival time of the first packet 702a in the second sequence from the arrival time of a packet in an earlier sequence.

The second controller 524-2 cannot determine a receiving frequency from a packet from the first sequence as no packet was received. Instead, the frequency is determined from the pre-defined list of receiving frequencies and an earlier received packet, i.e. if the receiving frequency determined for the first sequence was 2.403 GHz, then according to the list of receiving frequencies: 2.403, 2.423, 2.440, 2.461, 2.475 GHz, the next receiving frequency is 2.423 GHz. The second receiver 522-2 therefore listens on a frequency of 2.423 GHz.

The third controller 524-3 determines an expected arrival time of the first data packet 702a in the second sequence from the arrival time of the received packet 602a from the first sequence. The third receiver 522-3 listens on a frequency of 2.423 GHz, which is determined from the data packet 602a received from the first sequence.

As the expected arrival time calculated by each controller 524-1; 524-2; 524-3 is calculated in terms of time elapsed following the arrival of an earlier packet as measured by its respective clock, the estimated arrival times (and therefore the times at which the receivers 522-1; 522-2; 522-3 are switched on) will not necessarily be simultaneous.

In the exemplary cycle of the broadcast illustrated in FIG. 7, the first receiver 522-1 receives the first packet 702a in the first sequence, the second receiver 522-2 receives the second packet 702b in the first sequence, and the third receiver 522-3 receives the first packet 702a in the first sequence. Each receiver 522-1; 522-2; 522-3 is deactivated by its respective controller 524-1; 524-2; 524-3 after the respective packet 702a; 702b; 702a is received. Thus all three receivers 522-1 522-2 522-3 are inactive when packets are no longer expected, thereby conserving power.

The controller 524-1; 524-2; 524-3 of each pair of glasses calculates the time since transmission of the first packet 702a in the first sequence according to:

TimeSinceTransmission=Initialization Delay+TransmitTime+DecodeTime+(PacketNumber−1)*InterpacketDelay.

For the first pair of glasses 516-1, whose receiver 522-1 receives the first packet 702a, the time since transmission is:

TimeSinceTransmission=53 μs+281 μs+219 μs+(1−1)*500 μs=553 μs.

For the second pair of glasses 516-2, whose receiver 522-2 receives the second packet 702b, the time since transmission is:

TimeSinceTransmission=53 μs+281 μs+219 μs+(2−1)*500 μs=1053 μs.

For the third pair of glasses 516-3, whose receiver 522-3 receives the first packet 702a, the time since transmission is:

TimeSinceTransmission=53 μs+281 μs+219 μs+(1−1)*500 μs=553 μs.

Using the calculated values of the time since transmission, the respective clocks of all three pairs of glasses 516-1; 516-2; 516-3 are recalibrated.

The broadcast protocol may then proceed with further subsequent cycles of the broadcast protocol to maintain synchronisation of the clocks and thereby maintain synchronisation of the shutters of the glasses 516-1; 516-2; 516-3 with the alternating images on the television screen 504.

Thus it will be seen by one skilled in the art that in the described embodiment in which three viewers 514-1; 514-2; 514-3 are viewing the 3D television 502, a single transmitter 506 and associated control unit 512 implement the transmitter-side steps of the broadcast protocol, while each pair of glasses 516-1; 516-2; 516-3 simultaneously, and independently of each other pair of glasses, implements the receiver-side steps of the broadcast protocol. Further, the steps implemented by the transmitter 506 and the control unit 512 are carried out independently of the steps implemented by the glasses 516-1; 516-2; 516-3. Thus the broadcast protocol can be implemented simultaneously by an unlimited number of glasses, subject only to considerations such as physical space and line-of-sight to the screen for the viewers, power requirements for operating the television and glasses, and the cost of providing the television and glasses.

The skilled person will appreciate that the embodiments discussed above are merely illustrative and that many modifications and variations may be made within the scope of the invention. For example it is not essential to use the invention with a television but another display such as a computer screen, cinema screen, information screen or the like could be used.

Except where technically impossible, it is specifically envisaged that any feature or set of features may be used with any other feature or set of features; no inference is as to the essentiality of any feature to any other is to be drawn from the particular combinations of features disclosed herein.

1. A method for synchronizing a stereoscopic viewing apparatus with a display, the method comprising:
transmitting a signal generated by or synchronised with the display comprising a sequence of data packets, wherein each data packet in the sequence comprises an identifying portion of data;
the stereoscopic viewing apparatus receiving a data packet from the sequence of data packets;
identifying a position of the data packet in the sequence of data packets using said identifying portion;
determining timing information related to the data packet using said position; and
using the timing information for synchronization of the stereoscopic viewing apparatus with the display and for determining when to activate a receiver in the stereoscopic viewing apparatus for receiving a subsequent packet.

2. The method of claim 1 further comprising deactivating the receiver if a pre-determined number of packets has been received.

3. The method of claim 2 wherein the pre-determined number of packets is one.

4. A method as claimed in claim 1 further comprising determining a subsequent receiving frequency from the data packet.

5. A method as claimed in claim 1 further comprising:
subsequently transmitting a further sequence of data packets, wherein each data packet in the further sequence comprises an identifying portion of data; and
activating the receiver to receive said further sequence at an expected arrival time.

6. A method as claimed in claim 5 further comprising deactivating the receiver if a pre-determined time interval from said expected arrival time has elapsed.

7. A method as claimed in claim 1 further comprising selecting a subsequent receiving frequency from a list of receiving frequencies.

8. A method as claimed in claim 1 further comprising selecting a transmission frequency of the sequence of data packets from a list of transmission frequencies.

9. A method as claimed in claim 1 wherein a transmitter switches off when it is not transmitting.

10. A method as claimed in claim 1 wherein at least one data packet in the sequence contains a portion of data that is identical to a corresponding portion of data in a further data packet in the sequence.

11. A method as claimed in claim 1 wherein the signal is a radio signal.

12. A method as claimed in claim 1 wherein the stereoscopic viewing apparatus comprises a pair of glasses.

13. A stereoscopic viewing apparatus comprising:
a receiver configured to receive a data packet from a signal comprising a sequence of data packets; and
one or more processors configured to:
identify a position of the data packet in the sequence of data packets using an identifying portion of data in the data packet;
determine timing information related to the data packet using said position; and
use the timing information for synchronization of the stereoscopic viewing apparatus with a display and for determining when to activate the receiver in the stereoscopic viewing apparatus for receiving a subsequent packet.

14. The stereoscopic viewing apparatus of claim 13 wherein the one or more processors are further configured to deactivate the receiver if a pre-determined number of packets has been received.

15. The stereoscopic viewing apparatus of claim 14 wherein the pre-determined number of packets is one.

16. A stereoscopic viewing apparatus as claimed in claim 13 wherein the one or more processors are further configured to determine a subsequent receiving frequency from the data packet.

17. A stereoscopic viewing apparatus as claimed in any claim 13 wherein the one or more processors are further configured to activate the receiver to receive a further sequence of data packets at an expected arrival time.

18. A stereoscopic viewing apparatus as claimed in claim 17 wherein the one or more processors are further configured to deactivate the receiver if a pre-determined time interval from said expected arrival time has elapsed.

19. A stereoscopic viewing apparatus as claimed in claim 13 wherein the one or more processors are further configured to select a subsequent receiving frequency from a list of receiving frequencies.

20. A stereoscopic viewing apparatus as claimed in claim 13 wherein the signal is a radio signal.

21. A stereoscopic viewing apparatus as claimed in claim 13 wherein the stereoscopic viewing apparatus comprises a pair of glasses.

22. A display apparatus comprising a transmitter arrangement configured to transmit a signal comprising a sequence of data packets, wherein each data packet in the sequence comprises:
an identifying portion of data that is different from the identifying portion in each other data packet in the sequence; and
a payload portion of data that is identical to the payload portion in at least one other data packet in the sequence.

23. The display apparatus of claim 22 wherein the transmitter arrangement is configured to transmit a further sequence of data packets wherein each packet in the further sequence of packets comprises:
an identifying portion of data that is different from the identifying portion in each other data packet in the sequence; and
a payload portion of data that is identical to the payload portion in at least one other data packet in the sequence.

24. The display apparatus of claim 22 or 23 wherein the transmitter arrangement is further configured to select a transmission frequency from a list of transmission frequencies.

25. A display apparatus as claimed in claim 22 wherein the signal is a radio signal.

26. A display apparatus as claimed in claim 22 wherein a transmitter in the transmitter arrangement switches off when it is not transmitting.

27. A display system comprising:
a display apparatus as claimed in claim 22; and
at least one stereoscopic viewing apparatus as claimed in claim 13.
